(19) United States
(12) Patent Application Publication
(10) Pub. No.: US 2006/0084314 A1
(43) Pub. Date: Apr. 20, 2006

(54) Connector housing and electrical connector

(76) Inventor: Eiichiro Takizawa, Tokyo (JP)

Correspondence Address: BARLEY SNYDER, LLC, 1000 WESTLAKES DRIVE, SUITE 275, BERWYN, PA, 19312, US

(21) Appl. No.: 11/250,253

(22) Filed: Oct. 14, 2005

(30) Foreign Application Priority Data
Oct. 15, 2004 (JP) 2004-302275

(51) Int. Cl. H01R 13/627

(52) U.S. Cl. 439/352

(57) ABSTRACT

The connector housing of the present invention is a connector housing that fits together with a mating connector housing, comprising a housing cover member having a circular cross section, a first anti-rotation member detachably disposed around the outer periphery of the housing cover member, and a second anti-rotation member formed in a concave shape in the face of the housing cover member across from the mating connector.

### FIELD OF THE INVENTION

The present invention relates to a connector housing and to an electrical connector that makes use of the same, and more particularly relates to an electrical connector for connecting a lead to the squib of an automotive airbag device.

### BACKGROUND

The electrical connectors used to make electrical connections in various kinds of devices need to be small enough and have the appropriate shape as dictated by each application. For instance, an airbag that deploys in the event of an automotive collision in order to protect the occupants is not needed under normal conditions, and is therefore housed in a small space such as the steering column. An electrical connector called a squib connector, which is used to connect the lead wires supplying current to the electrical igniter (squib) of the inflator on the basis of an ignition signal from an electronic control unit (ECU), needs to be small and low in height so that such limited spaces can be effectively utilized.

FIG. 11 is an oblique view of an example of a conventional squib connector disclosed in Japanese Laid-Open Patent Application 2000-294343. This squib connector 50 is configured such that a pair of lead wires W for supplying ignition current from the electrical system of a vehicle to a squib are connected at the upper end of a housing cover member 51 at a right angle to the direction in which the connector is fitted, and the lower end of the housing cover member 51 is inserted into a connector (not shown) on the squib side. The upper part of the housing cover member 51 is provided with a housing component 52 that houses a ferrite core (not shown) for absorbing noise that could result in a malfunction of the airbag device. The housing cover member 51, which serves as the main part of the squib connector 50, is substantially cylindrical in form, so protrusions 51a corresponding to concave components in the connector on the squib side are provided so as to restrict rotation so that relative rotation will be impossible once the squib connector 50 has been inserted into the squib-side connector. Also, locking tabs 51d that latch locking grooves on the squib-side connector are provided so that the squib connector 50 will not fall out of the squib-side connector.

The most suitable electrical connector is selected for each device in which the connector is to be used, which creates a problem in that many different kinds of connector housings of correspondingly different shapes have to be available. Naturally, standardization is underway in certain applications, but up to now the shape of the locking means for preserving a fitted state or of the anti-rotation means provided to a connector whose housing cover member has a circular cross section has been determined individually according to the connector on the side of the device to which the first connector is to be fitted.

### SUMMARY

The present invention was conceived in light of this situation, and it is an object thereof, among others, to provide an interchangeable connector housing and connector that can be inserted into a plurality of types of connector housing having differently shaped housing cover members.

The connector housing of the present invention is a connector housing that fits together with a mating connector housing, comprising a housing cover member having a circular cross section, a first anti-rotation member detachably disposed around the outer periphery of the housing cover member, and a second anti-rotation member formed in a concave shape in the face of the housing cover member across from the mating connector.

With the connector housing of the present invention, a first anti-rotation member is detachably disposed around the outer periphery of a housing cover member having a circular cross section, and a second anti-rotation member is formed in a concave shape in the face of the housing cover member across from the mating connector, which means that interchangeability can be maintained no matter what kind of anti-rotation means the mating connector housing is equipped with.

An alternate electrical connector of the present invention comprises a housing cover member having a circular cross section and in which a contact is housed, a first anti-rotation member detachably disposed around the outer periphery of the housing cover member, and a second anti-rotation member formed in a concave shape in the face of the housing cover member across from the mating connector, which means that interchangeability can be maintained no matter what kind of anti-rotation means the mating connector housing is equipped with.

Specifically, with the present invention, when the housing on the mating connector side is designed such that anti-rotation is accomplished by a concave component provided around the outer periphery of the housing cover member, an anti-rotation member having a corresponding convex shape is mounted on the outer periphery of the housing cover member in order to accomplish anti-rotation. When the housing on the mating connector side is designed such that anti-rotation is accomplished by a convex component formed on a face across from the housing cover member, a dummy member having no convex component is mounted instead of the above-mentioned anti-rotation member having a convex component, which allows insertion and also accomplishes anti-rotation.

### BRIEF DESCRIPTION OF THE DRAWINGS

The invention will now be described with reference the accompanying figures of which:

FIG. 1 is an oblique view of the external appearance of a squib connector that is a preferred embodiment of an electrical connector constituted using the connector housing pertaining to the present invention;

FIG. 2 is an exploded oblique view of a state in which the anti-rotation member has been removed from the housing cover member of the squib connector in FIG. 1;

FIG. 3 illustrates an example of the squib-side connector, in which FIG. 3A is an oblique view including a cross section, FIG. 3B is a view of the fitting face from the squib connector side, and FIG. 3C is a cross section along the A-A line in FIG. 3B;

FIG. 4 illustrates another example of the squib-side connector, in which FIG. 4A is an oblique view including a cross section, FIG. 4B is a view of the fitting face from the squib connector side, and FIG. 4C is a cross section along the B-B line in FIG. 4B;

FIG. 5 is an oblique view of the shape of the dummy member attached to the anti-rotation member attachment component of the housing cover member instead of an anti-rotation member;

FIG. 6 is a diagram of the shape of the locking tab in a conventional squib connector;

FIG. 7 is a diagram of the shape of the locking tab in the squib connector of an embodiment of the present invention;

FIG. 8 is a partial oblique view illustrating a state in which the locking tab of the squib connector in an embodiment of the present invention is latched to a locking groove with a V-shaped cross section of the squib-side connector;

FIG. 9 is a partial oblique view illustrating a state in which the locking tab of the squib connector in an embodiment of the present invention is latched to a locking groove with a rectangular cross section of the squib-side connector;

FIG. 10 is an exploded oblique view of the squib connector in a preferred embodiment of the electrical connector in which the connector housing pertaining to the present invention is used; and

FIG. 11 is an oblique view of an aspect of a conventional squib connector.

### DETAILED DESCRIPTION OF THE EMBODIMENTS

An embodiment of the present invention will now be described in greater detail through reference to the drawings. Those components that are the same in the various drawings are numbered the same. For the sake of ease of description, the up and down and left and right directions in the drawings will be referred to in exactly that way.

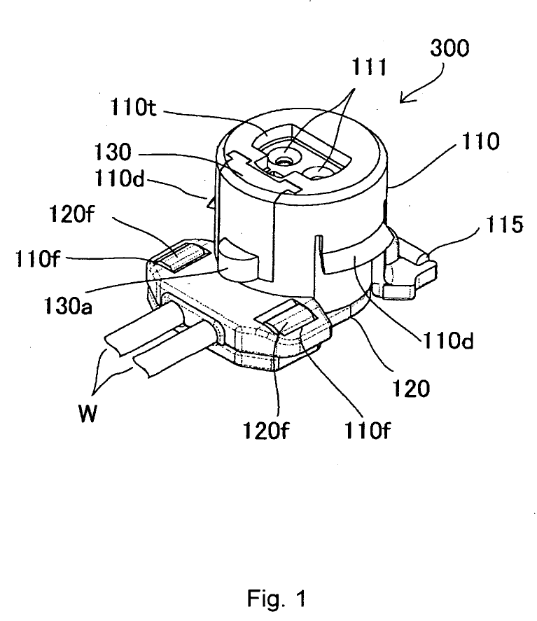

Referring to FIG. 1, a squib connector 300 is used to connect a pair of lead wires W for supplying ignition current from a vehicle power supply to the electrical igniter (squib) of an inflator that deploys an airbag in the event of a collision of the vehicle.

The housing of the squib connector 300 consists of a housing cover member 110, which serves as the main portion of the housing, and a housing cover 120. The ends of the pair of lead wires W connected to the electrical system of the vehicle are guided from the lower part of the housing cover member 110 at a right angle to the insertion direction of the connector, and are press-fitted to one end of a pair of contacts (not shown) housed in the housing cover member 110. The other end of these contacts is disposed so as to be located in a pair of contact holes 111 provided to a T-shaped concave portion 110t in the upper face of the housing cover member 110, and when the upper part of the housing cover member 110 is inserted into the connector on the squib side, a pair of contact pins (not shown) fit therein so as to form an electrical connection therebetween.

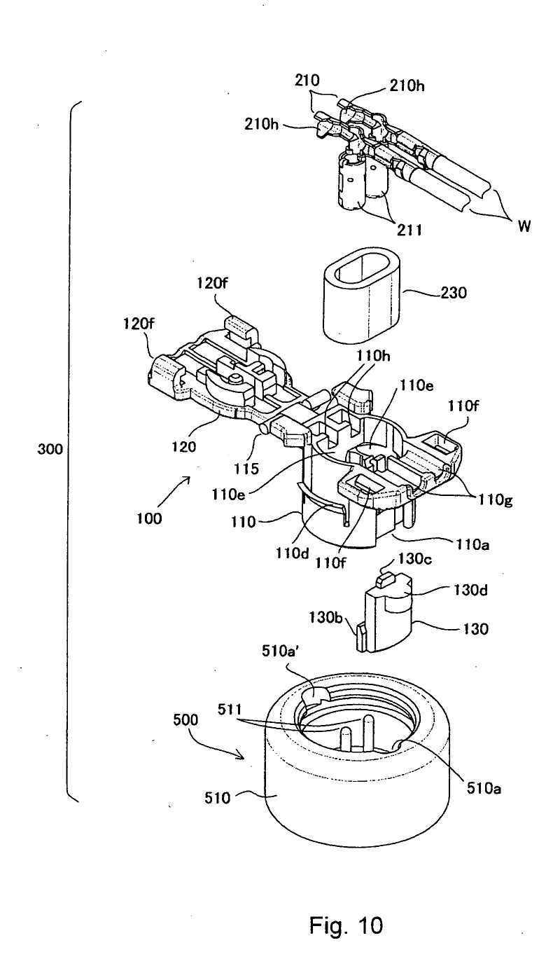

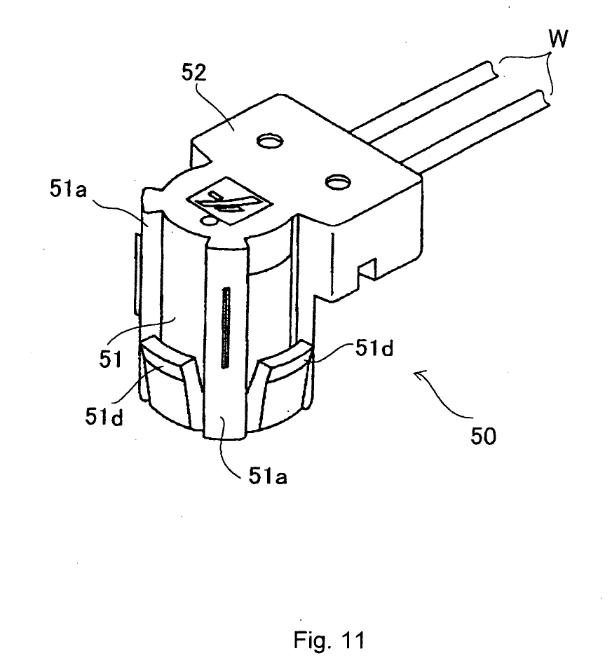

The housing cover 120 is attached at one end to the lower part of the housing cover member 110 via a hinge 115, allowing the other end to be opened and closed. When the pair of contacts press-fitted to the pair of lead wires W is housed in the connector housing cover member 110, fixing tabs 120f provided at the end of this housing cover 120 that is on the opposite side from the hinge 115 are fitted into fixing holes 110f in the housing cover member 110, so that the pair of lead wires W is held sandwiched at wire receiving sections 110g (see FIG. 10) in the housing cover member 110.

Since the housing cover member 110 and the squib-side connector both have circular cross sections, the squib connector 300 is able to rotate when mated with the squib-side connector. Accordingly, if there is no restriction whatsoever on relative rotation between the two, there is the danger of damage to the pair of contacts of the squib connector 300 and to the pair of contact pins of the squib-side connector that are fitted thereto. To prevent this, the squib connector 300 is equipped with an anti-rotation member 130. The anti-rotation member 130 is provided with a convex component 130a that protrudes in the radial direction from the housing cover member 110, and this is fitted into a concave component provided at a specific location of the squib-side connector, which restricts the squib connector 300 so that it cannot rotate when inserted in the squib-side connector. This anti-rotation member 130 is designed to be detachable from the outside of the housing cover member 110, and its shape can be selected as dictated by the type of anti-rotation means provided to the squib-side connector.

The squib connector 300 is also equipped with locking tabs 110d at two places on the outside of the housing 110, for keeping the squib connector 300 from falling out of the squib-side connector once inserted. As will be discussed below, the shape of these locking members 110d allows a locking regardless of the shape of the locking grooves provided to the squib-side connector.

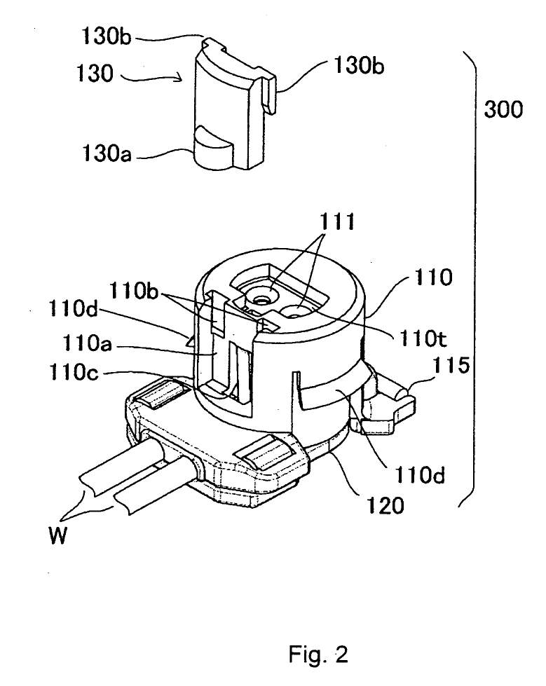

FIG. 2 is an exploded oblique view of a state in which the anti-rotation member 130 has been removed from the housing cover member 110. The anti-rotation member 130 is mounted by being pushed into the outer face of the housing cover member 110. Fixing components are provided at three places on an anti-rotation member attachment component 110a of the housing cover member 110, and the anti-rotation member 130 is fixed by these so that it will not come out readily. Protrusions 130b provided on both sides at the top end of the anti-rotation member 130 fit into grooves 10b provided on both sides at the entrance side of the attachment component 110a. A protrusion 130c (see FIG. 10) provided in the middle of the lower end of the anti-rotation member 130 fits into a concavity 10c provided in the butting face of the attachment component 110a.

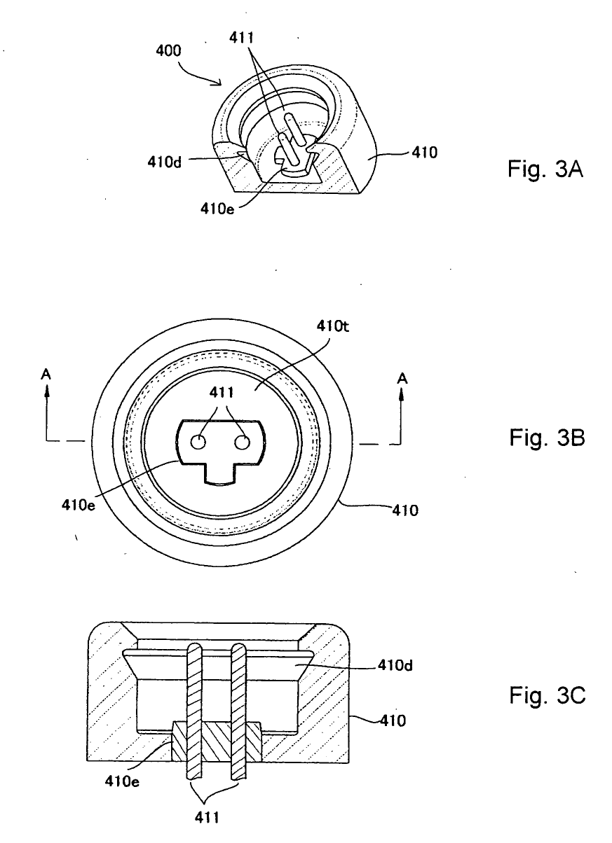

FIG. 3 illustrates an example of the squib-side connector into which the squib connector 300 is inserted. This squib-side connector 400 comprises a cylindrical housing 410 and a pair of contact pins 411 disposed at the bottom of this housing. The pair of contact pins 411 provided at the bottom of the housing 410 are connected to the squib of an inflator by passing through an insulating base 410e that supports these pins. The insulating base 410e is formed as a substantially T-shaped convex component inside the housing 410. This T-shaped convex component fits into the T-shaped concave portion 110t (FIGS. 1 and 2) formed at the distal end face of the housing cover member 110 of the squib connector 300 that is inserted into the housing 410. As a result, relative rotation between the squib-side connector 400 and the squib connector 300 inserted therein is restricted, and this also prevents the pair of contact pins 411 from being incorrectly connected to the pair of lead wires W.

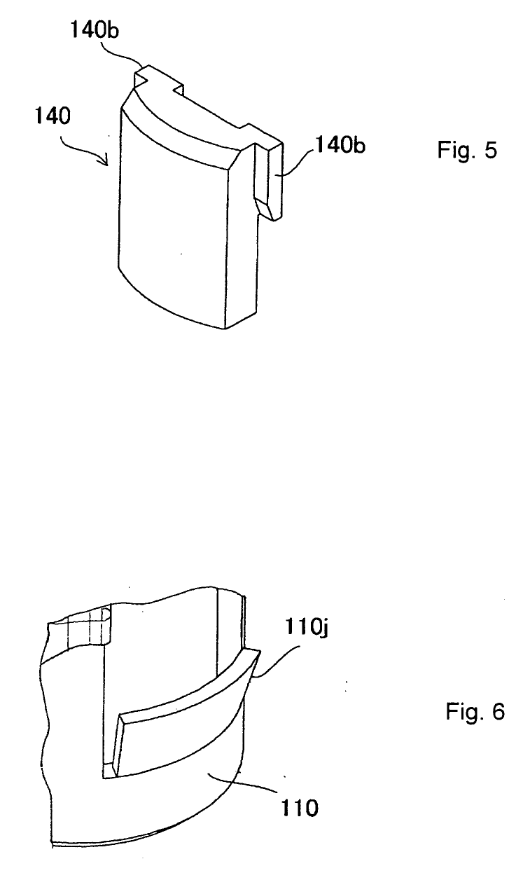

A dummy member 140 having no convex component as shown in FIG. 5 is attachable instead of the anti-rotation member 130 having the convex component 130a to the anti-rotation member attachment component 10a of the housing cover member 110 of the squib connector 300 that is inserted into the squib-side connector 400. As a result, even if the squib connector 300 is inserted into a housing 410 in which no concave component for restricting the rotation of the squib connector 300 has been formed at the entrance edge of the housing cover member, insertion down to the required depth will not be hindered by interference of the convex component 130a of the anti-rotation member 130.

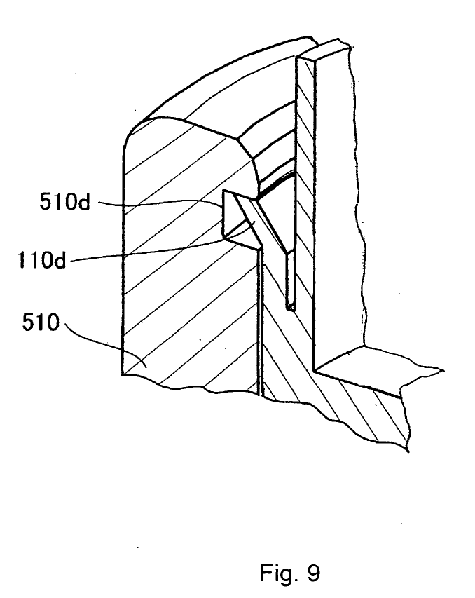

Referring to FIG. 8, a locking groove 410d that is substantially V-shaped in cross section is provided all the way around the inner face of the housing 410. Once the squib connector 300 has been inserted down to the required depth in the housing 410, the distal ends of the locking tabs 110d provided at two places on the outside of the housing cover member 110 spread out within the locking groove 410d and catch the upper edge thereof, which keeps the squib connector 300 from slipping out of the squib-side connector 400.

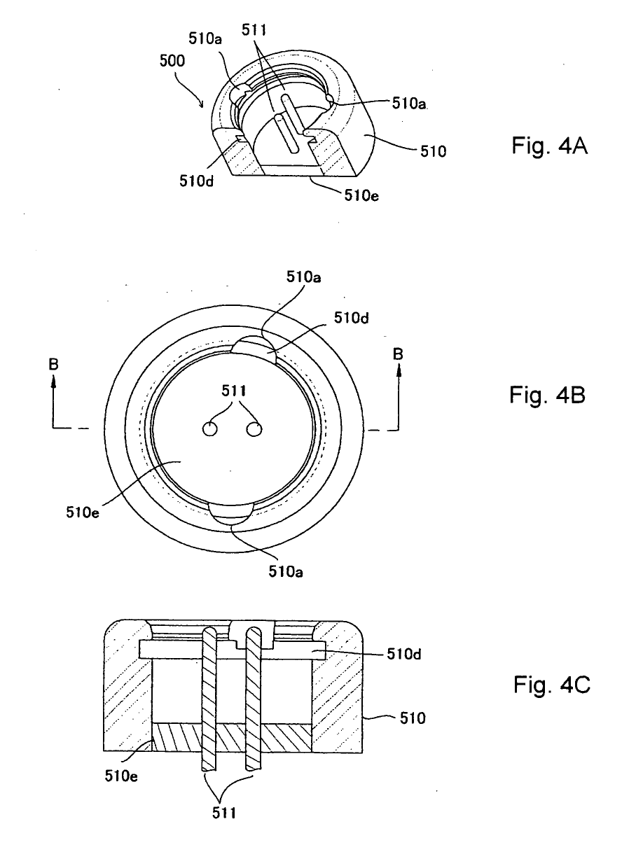

FIG. 4 illustrates another example of the squib-side connector into which the squib connector 300 is inserted. This squib-side connector 500 is similar to the above-mentioned squib-side connector 400 in that it comprises a cylindrical housing 510 and a pair of contact pins 511 disposed at the bottom of this housing, but differs in that semicircular concavities 510a are formed at the entrance to the housing 510. These semicircular concavities 510a are disposed asymmetrically at two places around the inner peripheral edge of the housing 510, and at least one of them is fitted to the semicircular convex component 130a provided on the outside of the squib connector 300, which restricts the rotation of the squib connector 300 and also prevents the pair of contact pins 511 from being incorrectly connected to the pair of lead wires W.

The squib-side connector 500 is also similar to the squib-side connector 400 in that a locking groove 510d is provided all the way around the inner face of the cylindrical housing 510, but differs in that the cross sectional shape of this groove is rectangular. Once the squib connector 300 has been inserted down to the required depth in the housing 510, the distal ends of the locking members 110d provided at two places on the outside of the housing cover member 110 spread out within the locking groove 510d and catch the upper edge thereof, which keeps the squib connector 300 from slipping out of the squib-side connector 500.

The locking groove provided to the inner face of the housing of the squib-side connector can have any of several different cross sectional shapes, such as the V-shape shown in FIG. 3 or the rectangular shape shown in FIG. 4. For example, for a squib-side connector having a V-shaped locking groove as shown in FIG. 3, a squib connector having locking tabs 110j of a simple shape as shown in FIG. 6 has been used. However, when a conventional squib connector having locking tabs with a simple shape such as this is inserted into a squib-side connector having a locking groove with a rectangular cross section, no locking function will be exhibited because the locking tabs will not completely catch the locking groove. Therefore, until now a number of different types of squib connector had to be made available according to the types of squib-side connector.

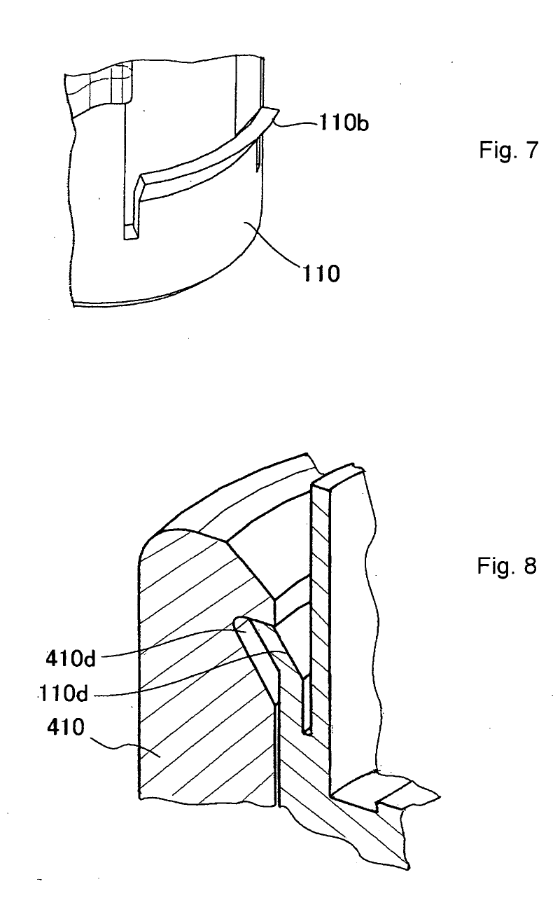

FIG. 7 shows the shape of the locking member provided on the outside of the housing cover member 110 of the squib connector 300 in an embodiment of the present invention. This locking member 110d is provided at two places on the outside of the housing cover member 110. Once the housing cover member 110 has been inserted down to the required depth in the squib-side connector, the tapered locking members 110d spread out within the locking groove by their own elasticity, and their distal ends interfere with the upper edge of the locking groove, which keeps the squib connector 300 in the squib-side connector.

FIG. 8 shows a state in which the locking tabs 110d of the squib connector 300 have been latched to the locking groove 410d with a V-shaped cross section of the squib-side connector. Specifically, the locking tabs 110d, which comprise elastic members that spread outward in a tapering form from the outside of the housing cover member 110, are able to spread out along the wall face of the locking groove 410d having a V-shaped cross section. Once spread out, these ends catch the upper edge of the locking groove and thereby restrict the squib connector 300 from slipping out of the squib-side connector, so a locking function is exhibited.

FIG. 9 shows a state in which the locking tabs 110d of the squib connector 300 have been latched to the locking groove 410d with a rectangular cross section of the squib-side connector. The locking tabs 110j of a conventional squib connector spread outward in a tapering form immediately from the outside of the housing cover member 110, such that there have been cases where they could not fit in a locking groove with a rectangular cross section. In such cases, the locking tabs 110j could not effectively lock the connector because their expanded ends did not catch the upper edge of the locking groove 510d. In contrast, the locking tabs 110d do not immediately spread out from the outside of the housing cover member 110, and instead spread out in a tapering form after first rising along the outside. Specifically, the portion that spreads out in a tapering form is shorter in height than with the conventional configuration, and when inserted in a squib-side connector having a locking groove with a rectangular cross section, the portions that have spread out in this tapering form are accommodated in the locking groove. Thus, the squib connector 300 can be inserted into any of a number of types of squib-side connector whose locking grooves have different cross sectional shapes.

Referring to the embodiment in FIG. 10, contacts 210 that are press-fitted to the pair of lead wires W are held in the housing 110 by fitting notches 210h of the contacts 210 into latching components 110h of the housing cover member 110. The above-mentioned pair of lead wires W guided to wire receiving sections 110g of the housing cover member 110 is sandwiched by the housing cover 120. Receptacles 211 are provided on the ends of the contacts 210 on the opposite side from the lead wires W, and are housed in receptacle housing sections 110e of the housing cover member 110, pass through the contact holes 111, and are fitted to the pair of contact pins 511 of the squib-side contact 500. A ferrite material 230 used for absorbing noise is disposed around the receptacles 211.

In the above description, the example was of a case in which an electrical connector was formed using the connector housing pertaining to the present invention, but embodiments of the present invention are not limited to this, nor are applications of the electrical connector limited to a squib connector.

What is claimed is:

1. A connector housing that fits together with a mating connector housing, comprising:
a housing cover member having a circular cross section;
a first anti-rotation member detachably disposed around the outer periphery of the housing cover member; and
a second anti-rotation member formed in a concave shape in the face of the housing cover member across from the mating connector.

2. The connector housing of claim 1 wherein the housing cover member has a locking tab extending outwardly therefrom.

3. The connector housing of claim 2 wherein the housing cover member has groves for receiving the first anti-rotation member.

4. The connector housing of claim 3 wherein the first anti-rotation member has protrusions extending outwardly therefrom which are received in the grooves.

5. The connector housing of claim 4 wherein the first anti-rotation member has a convex component formed on an outer surface thereof.

6. An electrical connector that fits together with a mating connector and forms an electrical connection, comprising:
a housing cover member having a circular cross section and in which a contact is housed;
a first anti-rotation member detachably disposed around the outer periphery of the housing cover member; and
a second anti-rotation member formed in a concave shape in the face of the housing cover member across from the mating connector.

7. The connector housing of claim 6 wherein the housing cover member has a locking tab extending outwardly therefrom.

8. The connector housing of claim 7 wherein the housing cover member has groves for receiving the first anti-rotation member.

9. The connector housing of claim 8 wherein the first anti-rotation member has protrusions extending outwardly therefrom which are received in the grooves.

10. The connector housing of claim 9 wherein the first anti-rotation member has a convex component formed on an outer surface thereof.
